(19) United States
(12) Patent Application Publication
(10) Pub. No.: US 2019/0378364 A1
(43) Pub. Date: Dec. 12, 2019

(54) Unattended physical delivery access method and itinerary control system

(71) Applicant: Dean Drako, Austin, TX (US)

(72) Inventor: Dean Drako, Austin, TX (US)

(21) Appl. No.: 16/206,353

(22) Filed: Nov. 30, 2018

Related U.S. Application Data
(63) Continuation-in-part of application No. 16/005,544, filed on Jun. 11, 2018, now abandoned.

(51) Int. Cl. G07C 9/00; H04W 4/029; G06Q 10/08

(52) U.S. Cl. CPC G07C 9/00015; G07C 9/00103; G06Q 10/08355; G07C 9/00119; H04W 4/029; G07C 9/00111

(57) ABSTRACT

An unattended physical delivery access control system includes a wireless mobile agent which journeys from multiple supply originations to many unattended delivery destinations through one or more actively communicative waypoints. In the vicinity of waypoints specified in an itinerary, the agent transacts tokens which are relayed to a cloud server. As the agent approaches the unattended delivery destination, the server verifies its credentials and the transit tokens transformed by waypoints. A portal actuator is operated by a physical access control server to enable delivery upon arrival and secure the portal upon departure. The agent is credentialed by each supply origination apparatus and receives destination, itinerary routing, and transit token(s). Waypoint identifiers may be recorded into the transit tokens by the agent. Each active waypoint acquires a token from the agent and relays it to the cloud server for validation.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Technical Field

The present invention relates to physical access control, access control mechanisms for managing physical delivery, physical access portals, or other physical resource access control methods and apparatus, wireless door actuators, locks, and security systems.

### Description of the Related Art

Quite a few small retailers require restocking of high volume or perishable products during low traffic hours. Examples would be baked goods, fruit, beverages, and newspapers. These are frequently placed curbside by delivery personnel prior to arrival of the employees who open the store or restaurant. In many cases, keys to the establishment are not entrusted to the delivery service because of the risk of loss or irregularity of scheduling. One reason may be high turnover among the least experienced and lower skilled part-time employees or contractors who are only in a trial or evaluation period. What is needed is a way to enable a supply service to operate a portal as needed for unattended delivery destinations without tracking and manual handling of physical keys among members of a delivery team.

Within this application the term physical access portal (portal) refers to a control point or boundary through which a person or vehicle or object can traverse if permitted or be denied transit whether it is an entrance or exit from or to a structure or area or region. Non-limiting examples of portals are doors, gates, lifts, elevators, and mailboxes.

As is known, mobile devices including wearable devices, communicating via the cellular telephone network, also include geo-location services by detecting signal strengths and phases from Global Positioning System (GPS) satellites, Wi-Fi Access Points, Cellular Base Stations, Bluetooth beacons, and other non-mobile signal emitters which have fixed or reliably predictable location.

As is known, mobile devices including cellular phones and wearables often include NFC, RFID, and Bluetooth transceivers.

### BRIEF SUMMARY OF THE INVENTION

Workers at a delivery service are equipped with mobile wireless devices that communicate with a physical access control server, that are capable of binding the device to a worker (a person) using a strong identity verification process such as a biometric verification, PIN or password challenge, gesture recognition or other authentication mechanism that is part of the operating system on the device or that is installed as add-on capability through software or hardware attached to the device.

A delivery service equips their workers with a mobile wireless device to perform their work (either a personal device augmented in some way or a device provisioned by the delivery service). Within this application the term agent refers to capabilities of that appropriately equipped and authorized mobile wireless device by the worker.

A delivery service is equipped with mobile wireless agents which communicate with a physical access control server. Each unattended delivery destination is coupled to the physical access control server to actuate a portal. A member of the delivery team receives cargo, a schedule, and a route at a supplier origin that authenticates the agent, and provides waypoint tokens and delivery destinations.

An unattended physical delivery access control system includes a wireless mobile agent which journeys from supply originations to unattended delivery destinations by one or more waypoints.

In the vicinity of waypoints specified in an itinerary, the agent transacts tokens which are verified either by a cloud server or within the agent.

As the agent approaches the unattended delivery destination, the agent presents its credentials, transit tokens, and journal of the waypoints verified along the route.

Upon arrival a physical access control server evaluates permissions for entry and when authorized activates a portal actuator to grant access according to the access control parameters that govern the portal. Upon departure, or according to access control parameters (such as a time limit) the portal is re-secured.

The agent is credentialed by each supply origination apparatus and receives destination, itinerary routing, and transit tokens.

Some waypoint identifiers are recorded into the transit tokens within the agent. Other waypoints actively acquire a token from the agent and relay it to the cloud server for identity measure checking.

A supply net may include multiple origination points with deliveries to unaffiliated destination portals. That is, there will not be a single client or customer organization either sending or receiving goods.

An Access System includes: A wireless mobile agent communicatively coupled to the following networked apparatus; an unattended destination portal; at least one actively communicative location waypoint (such as a prior delivery destination); at least one supplier origination apparatus; and a cloud-based physical access control server.

A method of operation for an unattended portal access system comprises: establishing a credential with at least one supplier origination apparatus; receiving destination, journey routing, and transit tokens; transacting a transit token with at least one actively communicative location waypoint; and performing at least one unattended portal transaction.

A system includes a server coupled to a plurality of wirelessly connected mobile devices. The server receives through a wireless communication network a request to enable physical access at a portal using a secure channel and an approximate location from a mobile device. A circuit of the mobile device receives radio signal magnitude, phase, and power from at least one transmitter and authentication input from a user interface. Dual secured communications paths protect the server on its separately provisioned request channel and actuator command channel.

The mobile device transforms location data from among Global Positioning System satellites, cellular base stations, Wi-Fi Access Points, Bluetooth beacons and other radio signals with known locations into an approximate location with enough precision to uniquely identify a specific portal on a specific floor of a structure.

An access control server, securely coupled to a door control actuator, determines that a verified user is allowed access according to a set of rules. An exemplary rule enables physical access to an authenticated user within a range of time at a location when a one-time open command is received via a private channel.

The physical access control server is connected to at least one physical access portal and transmits a command to grant or deny access upon receiving and verifying a request from a mobile device via a wireless network. The wireless network may use Internet Protocol. The wireless network may use cellular data communication protocols.

A software module is installed from a secure store to a mobile device. A public/private key pair is generated during download, installation, or launch for each instance of an installed app. A public/private key pair may be used for communication with the access server. A digital certificate may be used for transport layer encryption.

The access server can be provisioned within the secured premises or the access server can be provisioned by a shared service in the cloud.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of communicatively coupled system components;

FIG. 2 is a block diagram of circuits in a mobile device apparatus;

FIG. 3 is an exemplary location identifier such as a waypoint device;

FIG. 4 is a data flow diagram illustrating an embodiment of the components of the system;

FIG. 5 is a data flow diagram illustrating an embodiment of a pre-approved destination access process;

FIG. 6 is a block diagram of a processor suitable for performance of a method embodiment; and

FIG. 7 is an illustration of processes in a method embodiment.

FIG. 8 is a flowchart of processes of a method embodiment.

### DETAILED DISCLOSURE OF EMBODIMENTS OF THE INVENTION

A delivery service is equipped with mobile wireless agents which communicate with a physical access control server. Each unattended delivery destination is coupled to the physical access control server to actuate a portal. A member of the delivery team receives cargo, a schedule, and a route at a supplier origin which authenticates the agent, and provides waypoint tokens and delivery destinations.

A hybrid network is composed of wired and wireless communication channels coupling the following components. The system enables unattended deliveries of goods at destinations using journeys which start from origination points and pass by waypoints. The waypoints either transmit or receive tokens installed in a mobile wireless device at the origination. The destinations receive credentials and a journal of waypoints from the wireless device. When the journaled tokens received at or transmitted by waypoints and the credential is matched at an access control server with an itinerary assigned at an origination point, an actuation command to a portal enables access.

A supply net may include multiple origination points with deliveries to unaffiliated destination portals. That is, it is unnecessary to restrict a service to a single client or customer organization either sending or receiving goods.

The Apparatus of the system consists of the hybrid network communicatively coupling at least one of each of the following: an agent installed on a mobile wireless device, a cloud access control server, an origination point, an actively communicative waypoint, and a destination having a remotely actuated portal. A hybrid network consists of wireless and wired communication channels. This includes Ethernet, Bluetooth, RFID, Wi-Fi, cellular, LTE, and 802.11 as examples.

An agent installed on a mobile device includes appropriate software library or instructions and data to perform interactions, with the appropriate level of authentication either using explicit verification (biometric, PIN, password) or using capabilities intrinsic to the device. This binds the team member to the device/app when performing transactions on the route. The binding can be strong and long lasting (such as with an employee) or can be short or temporal based on attributes of the person (e.g. over 18 and in possession of a valid in-state driver's license).

The device can be a personal device owned by the team member and provisioned with the appropriate software, or it can be a floater device that is temporarily assigned to the team member. Floater devices will require an initialization transaction to bind a particular team member to the floater device.

An origination apparatus provides authentication and credentialization for one or more deliveries in at least one controlled journey start location.

Where the product delivery originates is generally centralized and well equipped with inventory and information technology.

Waypoint examples include: a point of reference location on a delivery route. A waypoint can be a GPS location, a place (building or venue), a street intersection or other landmark that is used for the purpose of navigation on or along a route. An actively communicative waypoint transacts a token with the device and forwards it to a cloud based access control system server.

Signals denoting a waypoint include as a non-limiting example, light or sound at a certain frequency, a radio signal such as BLE or Wi-fi or an observable token, such as a number, a QR code or a pattern that can be observed and recorded by the mobile device. Waypoint technology may have security measures in place to ensure that signals can be proved genuine and prevent replay attacks; such as digital signatures, one time codes, cryptographic operations, checksums or nonces that are either part of the communications protocol or built on top.

A passive waypoint includes sensors that maintain a passive role by emitting a signal that mobile device can detect and authenticate. The waypoint does not necessarily observe or record signals and does not necessarily communicate back to a central system. When a waypoint is in the passive role, it is the mobile device that observes and records waypoint signals and communicates them to a server.

An actively communicative waypoint includes sensors that maintain an active role, observing and recording signals from participating mobile devices, transforming, and communicating that information back to a central system. The mobile device does not necessarily observe or record signals from active waypoints. This makes active waypoints well suited to unknown or previously unregistered mobile devices that are difficult to trust.

Apparatus at or proximate to the Destination includes circuits whereby a trigger sends an access request to an access control server. In the vicinity of the access control portal, a location credential such as a beacon, a Wi-Fi id, a global positioning system (gps) coordinate, or QR-code indicates the portal for the access control request.

Upon arrival at a delivery destination, a series of access control commands are transmitted to the portal control actuator valid during the presence of the agent at the destination.

A cloud-based physical access control server provides a credential for each agent.

A route specific credential that can be used to unlock doors that are associated with the route, so long as parameters of the route are adhered to. Such credentials may be long lasting and valid for multiple routes.

The credential may include cryptographic keys necessary to securely record observations on the mobile device. The credential can be a digital token, a cryptographic key, X.509 certificate.

The system maintains a history of validation throughout the route that is used to grant access; or data may be collected by the phone and submitted as part of the access request at the destination. Additional security measures may be in place to digitally sign the payload on the mobile device to ensure it is genuine.

The cloud based server process includes verifying the journey start, waypoints, and arrival at a destination.

Upon verification, the server process includes transmitting one or more access control commands to a portal control activator valid for a limited time.

The method of operation of the system consists of processes at the origination point, at the agent installed on a mobile device, at waypoints specified in an itinerary, at a destination, and at an access control system server

Authenticating at supply origination includes securely provisioning the mobile device with a credential; binding the authenticated user to the mobile device; and issuing the credential for a route (or routes); and storing the credential securely on the mobile device. A mobile wireless device assigned to a delivery team member is authenticated and credentialed for a supply journey to one or more destinations.

This includes a strong authentication checking of the team member, such as by performing biometric scan, driver's license validation, equipment check and so on, depending on the requirements of the route. Validation may be supervised by or observed by a trusted entity such as authenticated employee and recording the interaction.

Transferring itinerary, transit tokens, destinations, routing data from server to device is a process that enables the mobile device to maintain a directory of waypoints and their associated traits whereby the device can be used to attest to a journey even when the mobile device is not continuously connected to the network.

The itinerary includes a collection of rules and thresholds that apply to the route, such as allowed time intervals between waypoints, deviations from waypoints, continuity and consistency traits (taking the same path each time), traversal of waypoints in order, out of order or identifying waypoints that are optional or mandatory.

The process includes transacting a transit token with at least one location waypoint.

Waypoint Transactions include detecting location payload by mobile device. Using cryptographic processes based on the credential enables storing securely on the mobile device (or transmitting privately when connected).

Connected/Disconnected processes include: operating the mobile device when connected or disconnected; recording signals from waypoints on the device while it is disconnected from the system and validating at the destination.

Storing recorded information securely on the phone such that tampering and replay are prevented.

The system may determine the location of a mobile device using location services within the operating system of the device or using location services as part of an application running on the phone.

In the vicinity of waypoints specified in an itinerary, the agent performs transacting tokens which are verified by a cloud server or within the agent.

In an embodiment, this includes recording waypoint identifiers into the transit tokens by the agent.

Other waypoints perform actively acquiring a token from the agent and relaying it to the cloud server after transformation.

Sensors and communication signals in the vicinity of the waypoint in combination with sensors and communication signals on the mobile device determine when a delivery team member has checked in at a waypoint.

The degree of accuracy necessary for a team member to check in can be determined based on factors such as radio signal strength, observation and recording of a temporary stimulus, a physical interaction with machinery (a gas pump, an ATM, a barrier or lock), a behavior such as driving over a sensor or using a certain lane (e.g. triggering an EZ pass transponder).

A check in at a waypoint can be accepted within a variable boundary or range. The boundary may be based on the physical distance between the mobile device and the waypoint. This distance can be determined by sensors on the mobile device, or around the waypoint or a combination of the two. One skilled in the art will recognize that a boundary can be a regular shape such as a circle with a radius about the waypoint, or can irregular shape such as a polygon about the waypoint or a closed volume of space.

Applying transformations to a predefined geometry can also approximate the distance to the waypoint, such as observing a radio tower on the top of a large building and using that to check in at the ground level entrance.

A third party observation or assertion can be used to accept check in, such as an assertion by an attendant at a cash lane, instead of automatic detection in an EZ pass lane.

The system is robust in not requiring constant communication with the waypoint. It may only be necessary for the waypoint to communicate with the system periodically, thus supporting intermittent outages.

Passive waypoints are generally lower cost, relying on mobile device to do the work of observing, recording and authenticating the signal. This is well suited to an environment where the mobile devices are known and trusted.

An actively communicative waypoint transforms the data (aggregation, manipulation) before sending back to the central system.

Self Asserting waypoint attainment provides for certain conditions when communication between waypoints and mobile devices may be interrupted or unable to connect. The system allows trusted carriers to self-assert their position on their mobile device. Unattended Delivery Processes include performing at least one unattended portal transaction. This includes presenting the agent's credentials and journal of waypoints as the agent approaches the unattended delivery destination,

Operating a portal actuator by a physical access control server enables delivery upon arrival and secures the portal upon departure.

Delivery Transactions include using a strong authentication challenge at the destination, the system ensures the successful delivery of goods by the carrier. This may be a frictionless transaction, such as the mobile device observing a radio signal (BLE, Wi-Fi, etc.) without any interaction required or may require the carrier to level up the authentication in order to yield the desired level of trust by interacting with the system to validate a QR code, a PIN, a biometric, etc.

A delivery team member may provide additional annotations, comments, attach photos or observations if they have any concerns. Validation is typically unsupervised, but may be supervised by or observed by a trusted entity such as authenticated employee and the system may record the interaction. The system operates by recording that the transporter has delivered the goods and that the route is complete.

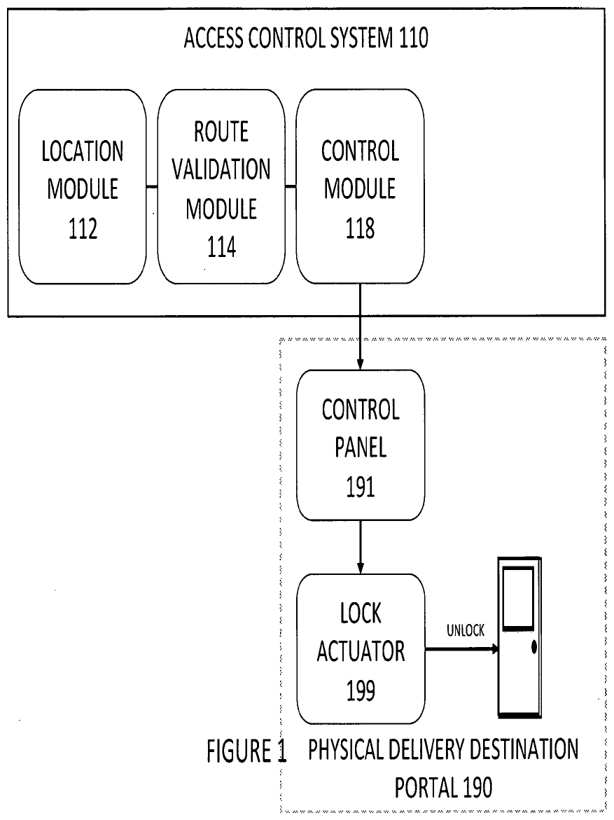

Referring now to the figures an exemplary embodiment of the invention is illustrated. FIG. 1 One embodiment of an access control system 110 and its coupled delivery portal 190 is shown in FIG. 1. At each physical delivery portal 190 there is a control panel 191 which is communicatively coupled to a control module 118 of the access control system 110 to receive commands to unlock or lock a door. Such commands could include which door, when, and for how long. The communication link may be public or private and involve cryptographic signatures or tunneling. The location module 112 determines that a mobile device is within range of its destination. The route validation module 114 checks that the mobile device has journeyed according to its itinerary by observation of waypoints by the device and observation of the device by waypoints. The control module 118 determines that the access control rules are matched for the physical access by the device carrier and issues a command to the destination portal 190.

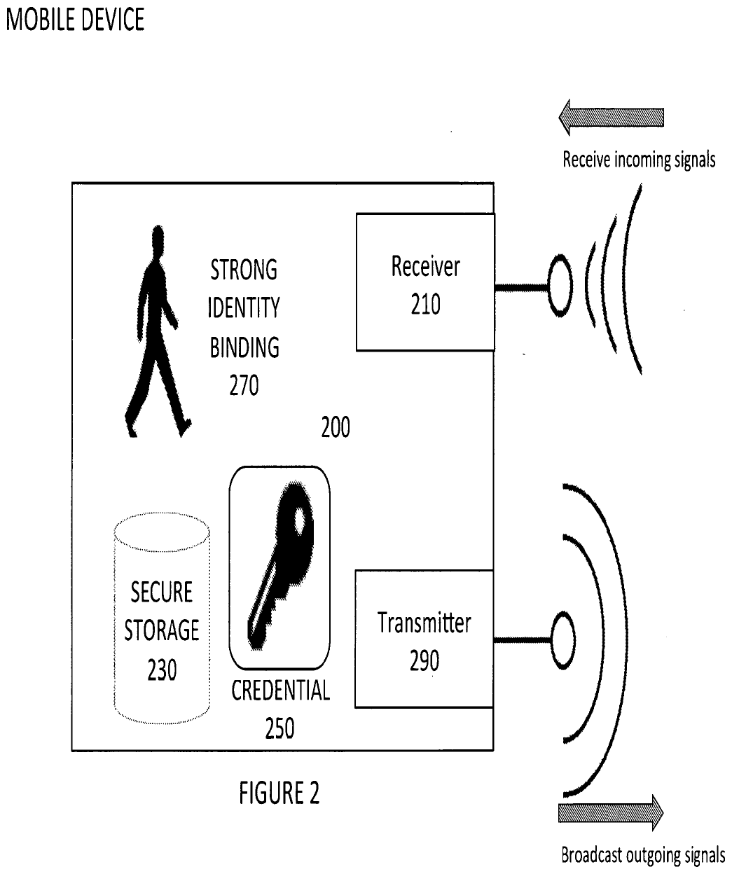

FIG. 2 One embodiment of a mobile device 200 has a receiver 210, a transmitter 290, and secure storage 230. A credential 250 is installed on the mobile device. The device is linked to a member of the delivery team by a strong identity binding 270.

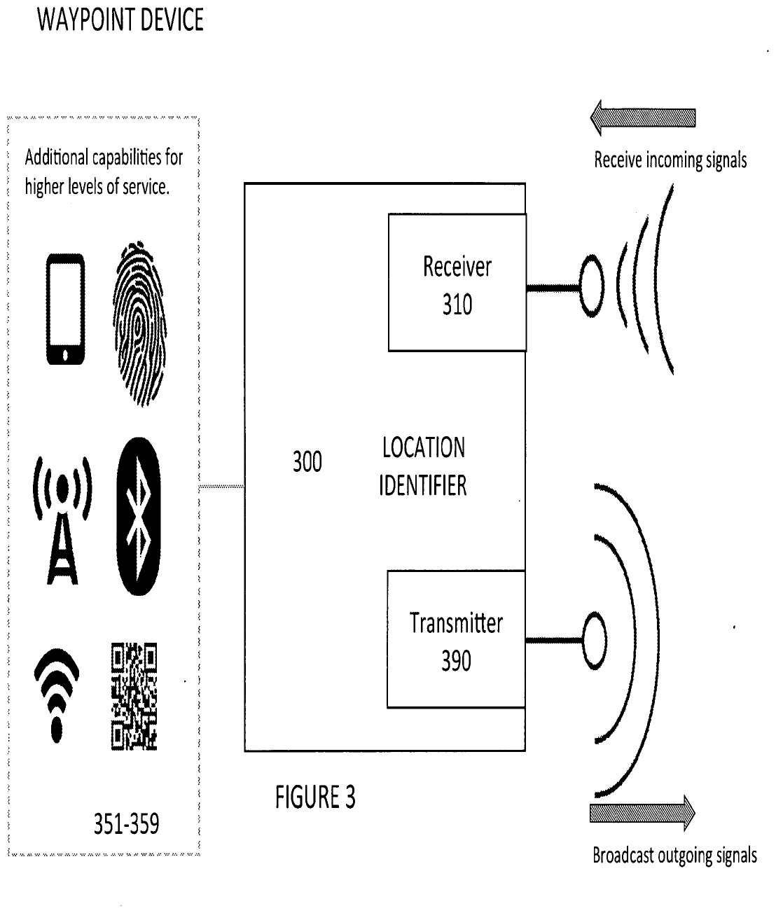

FIG. 3. One embodiment of a waypoint device is a location identifier 300 which has at least one of 390 a transmitter and 310 a receiver. Additional capabilities make use of signal sources or identifiers inherent in the route itinerary 351-359. A cellular base station, Bluetooth beacon, or Wi-Fi hotspot known to the location module can be a waypoint which is sensed and recorded by the mobile device. An image such as a QR code can be positioned at certain waypoints or at a destination. A waypoint can be asserted by taking a fingerprint on a mobile device in combination with other identifiers such as a GPS signal. Waypoints receive data from the mobile device and forward it to the access control system after transformation such as signature, encoding, and timestamp.

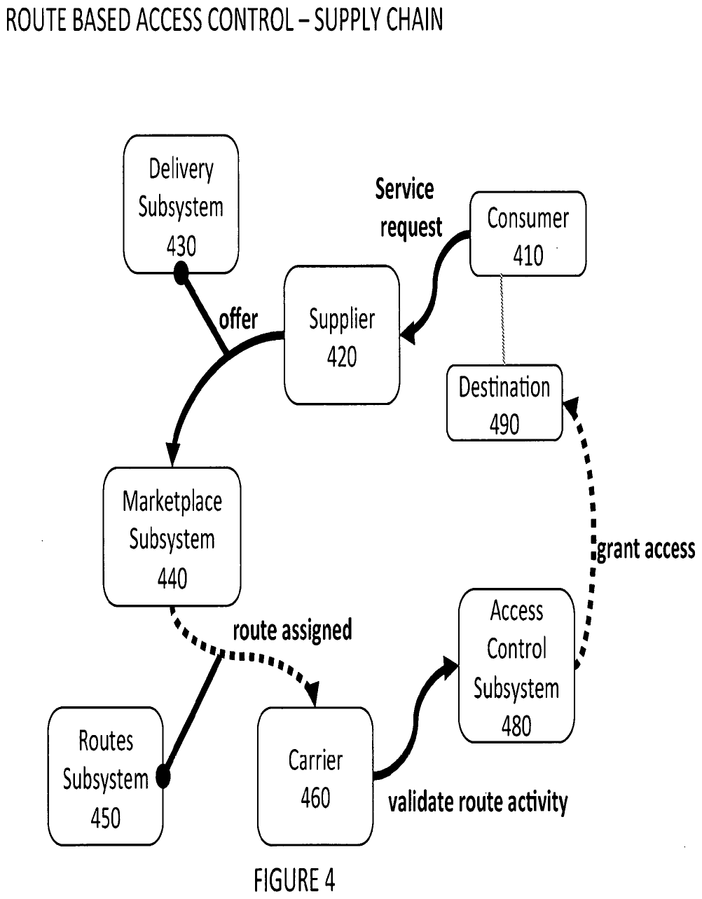

FIG. 4. A conceptual data flow diagram illustrates one embodiment of the invention in FIG. 4. A consumer 410 initiates a service request to a supplier 420 for physical delivery of goods to a destination portal 490. The supplier engages with a delivery subsystem 430 to obtain a transportation offer. Within a Marketplace Subsystem 440 a transportation order is issued. A Routes Subsystem 450 determines an itinerary for at least one destination through at least one waypoint. A route is assigned to a Carrier 460. As the carrier travels the route, its journey is recorded at waypoints by the waypoint itself or on a mobile device (not shown). The journal of the waypoints is provided to the Access Control Subsystem 480 which upon verification issues a command to grant access to the destination portal 490. Waypoints may exchange data with the mobile device, observe the mobile device, or be observed by the mobile device.

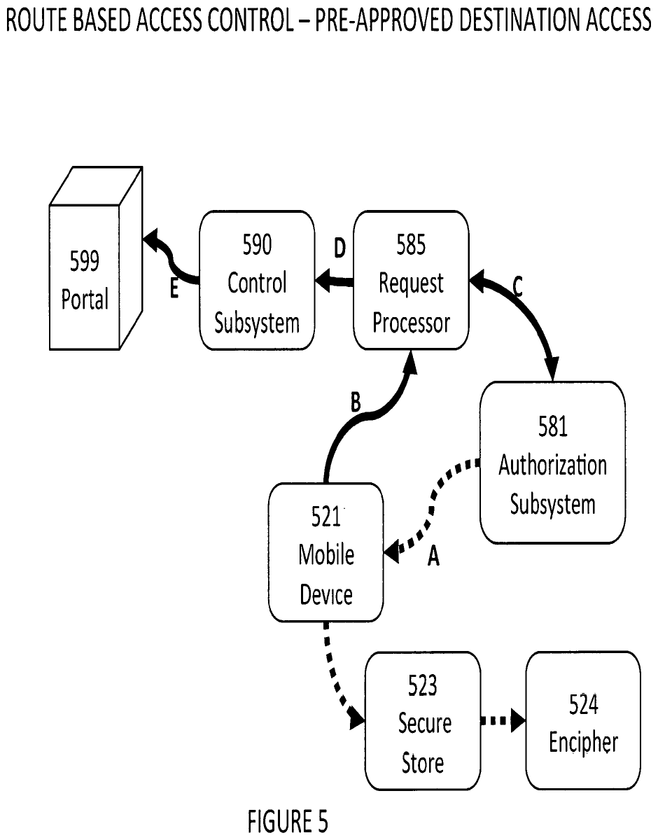

FIG. 5 A pre-approved destination access dataflow diagram is illustrated in FIG. 5. During the pre-approval process A, the Authorization Subsystem 581 installs software, a credential, an itinerary, and routing into a mobile device 521. The secure store 523 is transformed by encoding this by its encipher circuit 524. As the Mobile Device 521 approaches the destination it submits its credentials and journal of waypoints (if any) B to a request processor 585. The request processor verifies C by forwarding data to and receiving access permission from the authorization subsystem 581. Upon receiving verification, the request processor transmits D a command to the control subsystem 590 enabling access to a certain portal. The Control Subsystem 590 operates E an actuator to a portal 599 to enable unattended physical delivery.

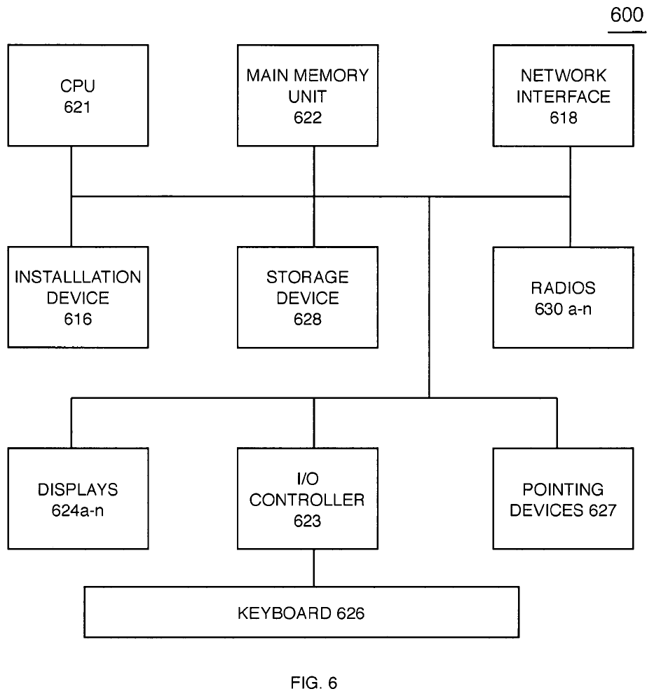

FIG. 6 Exemplary processors suitable for the performance of method embodiments to sense waypoints and control delivery destination portals are illustrated in FIG. 6. FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, GPS, and Wi-Fi radios. The storage device 628 may include, without limitation, an operating system and software. The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein. Main memory unit 622 may be one or more memory chips capable of storing data and allowing any storage location to be directly accessed by the microprocessor 621. The main memory 622 may be based on any available memory chips capable of operating as described herein. Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein. A computing device 600 of the sort depicted in FIG. 6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10 and WINDOWS VISTA, manufactured by Microsoft Corporation of Redmond, Wash.; MAC OS and iOS, manufactured by Apple Inc., of Cupertino, Calif.; or any type and/or form of a Unix operating system. In some embodiments, the computing device 600 may have different processors, operating systems, and input devices consistent with the device. In other embodiments the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; Nokia of Finland; Hewlett-Packard Development Company, L.P. and/or; Sony Ericsson Mobile Communications AB of Lund, Sweden; or Research In Motion Limited, of Waterloo, Ontario, Canada. In yet other embodiments, the computing device 600 is a smart phone, Pocket PC Phone, or other portable mobile device supporting Microsoft Windows Mobile Software. In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

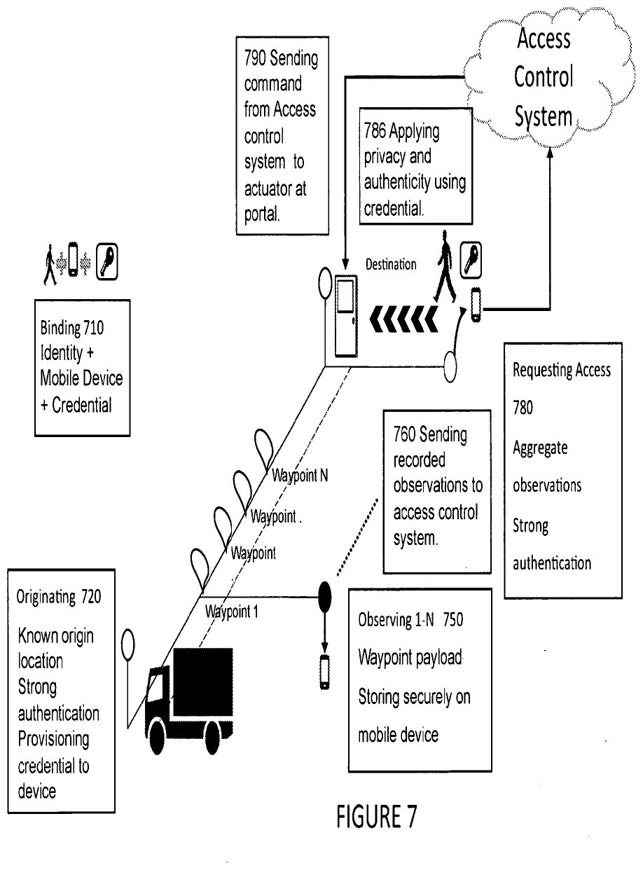

FIG. 7 An embodiment for operating the Access Control System is illustrated in FIG. 7. The processes include 710 binding the mobile device using a credential to an operator or delivery team member. This can be done for various lengths of time. Process 720, at a known origination location, originating 720 a journey by provisioning a credential, itinerary, and destination using strong authentication. Process 750 during the journey to the destination, observing at least 1 waypoint either stored on the mobile device or in another embodiment (not shown) recording the device transit by the waypoint. Process 760 sending recorded waypoint observations to the access control system by the mobile device, by the waypoint or both. Process 780 includes requesting access, using strong authentication in the proximity of the delivery destination portal. Process 786 includes applying privacy protocols and ensuring authenticity by using credentials installed in process 710. Process 790 includes sending a portal access command from an access control system to an actuator at a portal.

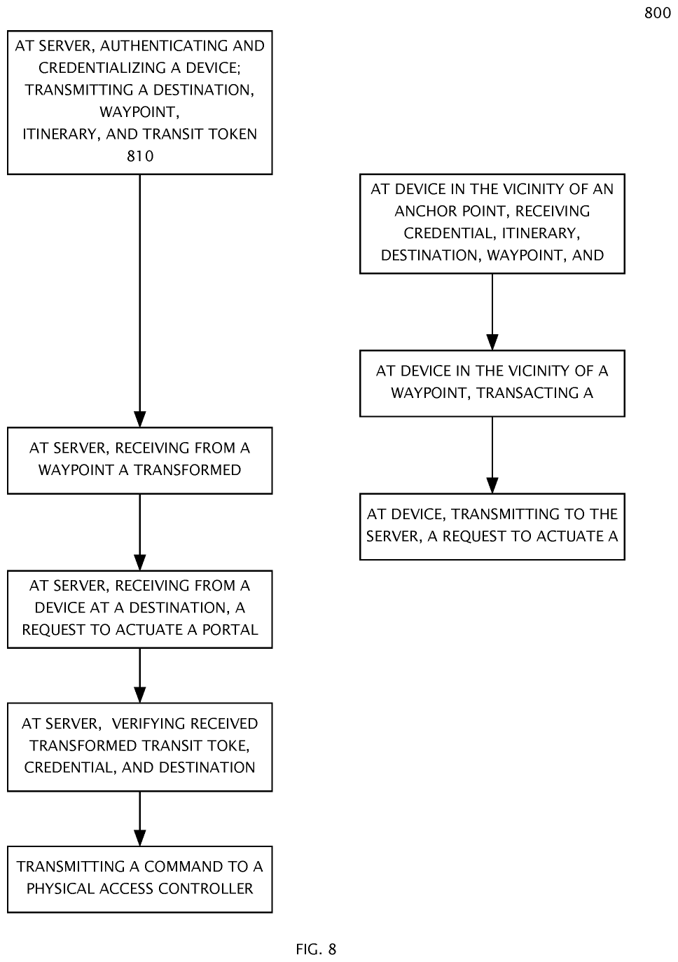

Referring now to FIG. 8, another embodiment for operation of an access control system is a method 800 which includes the processes: at a server: authenticating and credentializing a device; transmitting a destination, waypoint, itinerary (waybill), and transit token 810; at a device: in the vicinity of an anchor point, receiving credential, itinerary, destination, waypoint, and transit token 820, and in the vicinity of a waypoint, transacting a transit token 822; at a server: receiving from a waypoint, a transformed transit token 830; at a device: transmitting to the server, a request to actuate a portal at a destination 840; at a server: receiving from a device at a destination, a request to actuate a portal 850; verifying received transformed transit token, credential, and destination location 870; and transmitting a command to a controller 890.

### CONCLUSION

The invention is distinguished by support for multiple supply originations unlike conventional delivery hubs or regional warehouses. The invention is distinguished by support for unaffiliated customer facing delivery destinations unlike franchises or chain stores. The invention is distinguished from conventional physical access control systems by unattended delivery destinations receiving goods directly from multiple originators. The subject of this patent application includes a wireless mobile agent which journeys from supply originations to unattended delivery destinations through one or more actively communicative waypoints.

One aspect of the invention is a journey-based physical access control system for multiple unaffiliated supply chain providers including: a cloud access control server (server); the server coupled to all of, a hybrid communication network (network); the network coupled to, a first plurality of supply origination authentication anchor points (anchor point); a second plurality of supply recipient destination portal actuators to enable physical access; a physical access controller; at least one actively communicating waypoint (waypoint) at a location in the vicinity of a supply recipient destination portal actuator; and a third plurality of location-sensitive mobile wireless devices (device) configured with an agent, wherein said network comprises wired and wireless communication channels. In an embodiment each device includes: at least one location sensor and, a store for at least one location of an actively communicating waypoint in the vicinity of a supply recipient destination portal actuator. In an embodiment, each anchor point includes: a trusted communication circuit to establish authentication and credentialization of the location-sensitive mobile wireless device at journey start. n an embodiment, each waypoint includes: a communication circuit coupled to the cloud access control server; a communication circuit coupled to at least one location-sensitive mobile wireless device (device); and a transformation circuit to receive a transit token from said device, and transform it with datetime and location for transmission to said cloud access control server.

Another aspect of the invention is a method for operation of a cloud access control server having processes: receiving transit tokens transformed by an actively communicative waypoint from a location-sensitive mobile wireless device; receiving a physical access request from a location-sensitive mobile wireless device to actuate a supply recipient destination portal; and transmitting to a physical access controller a command to actuate a supply recipient destination portal on a condition that a transformed transit token and a physical access request from a device match a previously stored supply chain waybill assigned to the device at an anchor point. In an embodiment, the method also includes: authenticating and credentializing a device; and transmitting a destination, waypoint, itinerary and transit token.

Another aspect of the invention is a method for operating a location-sensitive mobile wireless device including: connecting to a cloud access control server (server) at an anchor point; authenticating and installing a credential; receiving an itinerary, destination location, actively communicative waypoint location, and transit token; transacting a transit token with said actively communicative waypoint; and transmitting to the server, a request to actuate a portal at a destination.

The techniques described herein can be implemented in digital electronic circuitry, or in computer hardware, firmware, software, or in combinations of them. The techniques can be implemented as a computer program product, i.e., a computer program tangibly embodied in a non-transitory information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; internal hard disks or removable disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

1. A journey-based physical access control system for multiple unaffiliated supply chain providers comprising:
a cloud access control server (server); the server coupled to all of,
a hybrid communication network (network); the network coupled to,
a first plurality of supply origination authentication anchor points (anchor point);
a second plurality of supply recipient destination portal actuators to enable physical access;
a physical access controller;
at least one actively communicating waypoint (waypoint) at a location in the vicinity of a supply recipient destination portal actuator; and
a third plurality of location-sensitive mobile wireless devices (device) configured with an agent, wherein said network comprises wired and wireless communication channels.

2. The system of claim 1 wherein each device comprises:
at least one location sensor and,
a store for at least one location of an actively communicating waypoint in the vicinity of a supply recipient destination portal actuator.

3. The system of claim 1 wherein each anchor point comprises:
a trusted communication circuit to establish authentication and credentialization of the location-sensitive mobile wireless device at journey start.

4. The system of claim 1 wherein each waypoint comprises:
a communication circuit coupled to the cloud access control server;
a communication circuit coupled to at least one location-sensitive mobile wireless device (device); and
a transformation circuit to receive a transit token from said device, and transform it with datetime and location for transmission to said cloud access control server.

5. A method for operation of a cloud access control server comprising processes:
receiving transit tokens transformed by an actively communicative waypoint from a location-sensitive mobile wireless device;
receiving a physical access request from a location-sensitive mobile wireless device to actuate a supply recipient destination portal; and
transmitting to a physical access controller a command to actuate a supply recipient destination portal on a condition that a transformed transit token and a physical access request from a device match a previously stored supply chain waybill assigned to the device at an anchor point.

6. The method of claim 5 further comprising:
authenticating and credentializing a device; and
transmitting a destination, waypoint, itinerary and transit token.

7. A method for operating a location-sensitive mobile wireless device comprising:
connecting to a cloud access control server (server) at an anchor point; authenticating and installing a credential; receiving an itinerary, destination location, actively communicative waypoint location, and transit token;
transacting a transit token with said actively communicative waypoint; and
transmitting to the server, a request to actuate a portal at a destination.
